(19) United States
(12) Patent Application Publication
(10) Pub. No.: US 2015/0014007 A1
(43) Pub. Date: Jan. 15, 2015

(54) POWER TOOL

(71) Applicant: MAKITA CORPORATION, ANJO-SHI (JP)

(72) Inventors: Tomohiro Ukai, Anjo-Shi (JP); Tooru Itakura, Anjo-Shi (JP); Akinori Ito, Anjo-Shi (JP)

(21) Appl. No.: 14/369,258

(22) PCT Filed: Dec. 26, 2012
(86) PCT No.: PCT/JP2012/083590

§ 371 Date: Jun. 27, 2014

(30) Foreign Application Priority Data
Jan. 16, 2012 (JP) 2012006039

(51) Int. Cl. B25F 5/00; B25F 5/02

(52) U.S. Cl. CPC B25F 5/001; B25F 5/008; B25F 5/02
USPC 173/46; 173/216; 173/217

(57) ABSTRACT

A power tool includes an outer rotor electric motor, a spindle and a gear train, and a tool accessory can be attached the spindle. The gear train transmits the rotational output of the electric motor to the spindle, and the speed reduction ratio of the gear train may be less than the speed reduction ratio of the gear train would need to be if the motor were instead an inner rotor electric motor.

### TECHNICAL FIELD

The present invention relates to a power tool wherein an electric motor is provided in the interior and the motor serves as a drive source. For example, the present invention principally relates to a hand-held type power tool such as a screwdriver, a disc grinder, and the like.

### BACKGROUND ART

Japanese Laid-Open Patent Publication No. H07-214476 discloses a screwdriver wherein an electric motor is provided in the interior. The rotational output of the electric motor is reduced by a reduction gear, such as a gear train that meshes with the electric motor. The rotational output is further output to a spindle that attaches a driver bit. As a result, the driver bit rotates at the proper rotational speed and generates sufficient screw tightening torque.

Because the tool main body must be broad enough to provide the reduction gear in the interior, the center height of the tool main body is large. The center height is the height from a spindle axis to an end edge (back surface) of the tool main body. The lesser the center height, the more advantageous it is for screw tightening at a corner. Screw tightening at a corner is when, for example, the end part of a floor material near a wall is fastened with a screw. If a disc grinder has a short center height, then the depth of cut of the grinding wheel can be made larger. This makes it possible to improve the cutting work.

### SUMMARY OF THE INVENTION

### Problem to be Solved by the Invention

In conventional power tools, a gear train, etc. having an appropriate speed reduction ratio is interposed between the motor shaft of the electric motor and the spindle, which is parallel to the motor axis. Consequently, it is not easy to make the center height short. There is a need in the conventional art for electrician's tools that can shorten the center height of the power tool.

### Means for Solving the Problem

According to a first aspect of the invention, a power tool comprises an electric motor, a spindle, and a gear train. A tool accessory can be attached the spindle. The gear train transmits rotational output of the electric motor to the spindle. The electric motor is an outer rotor motor, wherein the speed reduction ratio of the gear train is less than a configuration that replaces the outer rotor motor with an inner rotor motor.

The outer rotor motor comprises a non-rotating stator and a rotor, which is disposed on the outer circumferential side of the stator. An inner rotor motor comprises a rotor on the inner perimetric side of a non-rotating stator. Accordingly, an outer rotor motor can output high torque at a lower rotational speed than the inner rotor motor. Consequently, the speed reduction ratio of the gear train can be set smaller than that of a configuration comprising an inner rotor motor. As a result, the diameter of the follower gear can be made small. Thus, the center height, namely, the height from the rotational axis of the spindle, which attaches a follower gear, to an end edge of a tool main body that houses the follower gear, can be made short.

Because the center height is shorter, the spindle can approach more closely to a wall, for example, in order to perform an operation such as screw tightening or drilling. Thus, the operability of the power tool can be improved.

According to another aspect of the present invention, the spindle can be disposed parallel to a motor axis of the electric motor. The rotational axis of the spindle can be located in an area that corresponds to a diameter of an outer rotor of the electric motor. Accordingly, the diameter of the follower gear can be made small in a screwdriver, for example, that comprises a spur gear as the follower gear. As a result, the distance between the rotational axis of the spindle and the motor axis can be made short. The rotational axis of the spindle can be located in the area corresponding to the diameter of the outer rotor. Thus, the center height can be made less than in the conventional art.

According to another aspect of the present invention, the spindle can be disposed such that it intersects a motor axis of the electric motor. A tip part of a motor shaft of the electric motor can be located in an area that corresponds to a diameter of a bearing that rotatably supports the spindle. Accordingly, the diameter of the follower gear can be made small in a disc grinder, for example, that comprises a bevel gear as the follower gear. As a result, the motor shaft tip part (the drive gear) of the electric motor, which meshes with the follower gear, can be located in the area corresponding to the diameter of the bearing that rotatably supports the spindle. Thus, the diameter of the follower gear is sufficiently small, and consequently the center height of the tool main body (the gear head part) that houses the follower gear can be made less than in the conventional art.

### BRIEF DESCRIPTION OF THE DRAWINGS

FIG. 1 is a longitudinal cross sectional view of a screwdriver.

FIG. 2 is a longitudinal cross sectional view of a disc grinder.

FIG. 3 is a partial cross sectional side view of a straight-type drilling tool.

### MODES FOR CARRYING OUT THE INVENTION

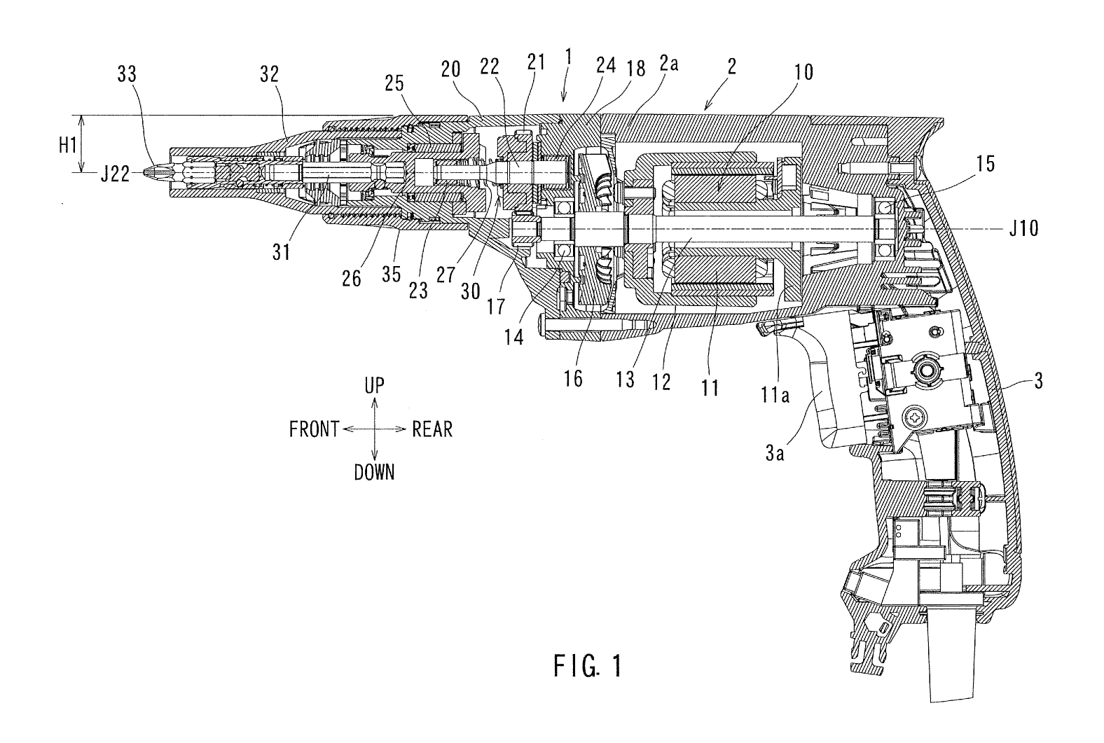

Embodiments of the present invention will now be explained with reference to the drawings. The power tool 1 shown in FIG. 1 is a hand-held type screwdriver. The power tool 1 comprises: a tool main body 2, which houses an electric motor 10, and a handle 3. A trigger type switch lever 3a is provided on a base part of the handle 3. The electric motor 10 is started by an operation wherein the fingertip of the hand that grasps the handle 3 pulls the switch lever 3a.

A so-called outer rotor type electric motor is used as the electric motor 10. The electric motor 10 can output a high torque at lower rotational speed than an inner rotor type. A stator 11 of the electric motor 10 is fixed to a rear part of a main body housing 2a via a pedestal part 11a. A circular cylindrical rotor (outer rotor) 12 is rotatably supported on the outer circumferential side of the stator 11. A motor shaft 13 is integrally attached to the rotor 12. The motor shaft 13 is rotatably supported about an axis (motor axis J10) by bearings 14, 15. The front bearing 14 is attached to an intermediate base 18, which is coupled to a front part of the main body housing 2a. The rear bearing 15 is attached to a rear part of the main body housing 2a. A fan 16, which is for cooling, is integrally attached to the motor shaft 13. When the electric motor 10 starts, the rotor 12 on the outer circumferential side of the stator 11 rotates, and the motor shaft 13 rotates about the motor axis J10.

A front end part of the motor shaft 13 passes through the front bearing 14, and further protrudes frontward from the intermediate base 18 and advances into a front housing 20. The intermediate base 18 is interposed between the front housing 20 and the front part of the main body housing 2a. The front housing 20 is coupled to the front part of the main body housing 2a via the intermediate base 18. A drive gear 17 is attached to the front end part of the motor shaft 13.

The drive gear 17 meshes with a follower gear 21. The follower gear 21 is fixed to a drive shaft 22. A spur gear, which has a relatively small diameter and a small tooth count, can be used as the follower gear 21. The gear train comprising the drive gear 17 and the follower gear 21 has a smaller speed reduction ratio than an inner rotor type electric motor. An inner rotor type electric motor comprises a circular cylindrical stator, and a rotor disposed in the interior of the stator. Accordingly, as compared to a power tool that comprises an inner rotor type motor, a follower gear 21 having a smaller diameter can be used.

The drive shaft 22 is rotatably supported about a rotational axis J22 by bearings 23, 24. The rotational axis J22 is parallel to the motor axis J10. The front bearing 23 is supported inside a center hole of a bit sleeve 26. The bit sleeve 26 is supported by the front housing 20 such that the bit sleeve 26 is capable of rotating about the rotational axis J22 via a bearing 25 and is capable of displacing in the rotational axis J22 direction. The rear bearing 24 is attached to the intermediate base 18.

A meshing clutch 30 is provided between a front surface of the follower gear 21 and a rear surface of the bit sleeve 26. A compression spring 27 is interposed between the follower gear 21 and the bit sleeve 26. The compression spring 27 urges the bit sleeve 26 frontward. The compression spring 27 urges in the direction away from meshing of the meshing clutch 30 (the direction that cuts off the motive power).

A bit holder 31, which functions as a spindle (output shaft), is mounted on the bit sleeve 26. An adjustment sleeve 32 is attached to the front housing 20. The bit holder 31 advances into the adjustment sleeve 32. A bit 33 is mounted at a tip of the bit holder 31. The bit 33 protrudes from the adjustment sleeve 32. An operating sleeve 35 is rotatably provided on the front housing 20. The operating sleeve 35 is screwed onto an outer circumferential surface of the rear part of the adjustment sleeve 32. By rotating the operating sleeve 35, the adjustment sleeve 32 displaces in the axial direction, which changes the amount by which the bit 33, which protrudes from the adjustment sleeve 32, protrudes. As a result, the amount by which the screw will be tightened can be adjusted.

The bit sleeve 26, the bit holder 31, and the adjustment sleeve 32 are coaxially supported about the rotational axis J22 of the drive shaft 22.

The bit 33 is brought into contact with the head part of a screw, and the power tool 1 is pushed in the screw tightening direction. As a result, the bit holder 31 and the bit sleeve 26 integrally move backward and the meshing clutch 30 meshes. The rotational output of the electric motor 10 is reduced by the meshing of the drive gear 17 and the follower gear 21. The reduced rotational output is transmitted to the bit 33 via the meshing clutch 30 and the bit sleeve 26. In the course of the tightening of the screw, the tip of the adjustment sleeve 32 comes into contact with the material being screwed. If the screw is further tightened, the bit 33, the bit holder 31, and the bit sleeve 26 integrally advance. Thereby, the meshing clutch 30 disengages, the meshing clutch 30 cuts off the motive power, and the screw tightening operation is completed.

As described above, the outer rotor type electric motor 10 is used as the drive source. The electric motor 10 can output high torque at a lower rotational speed than an inner rotor type electric motor. Consequently, the gear train comprising the drive gear 17 and the follower gear 21 can be set such that it has a comparatively small speed reduction ratio. As a result, the follower gear 21 can have a comparatively small diameter.

Accordingly, the distance between the rotational axis J22 and the motor axis J10 can be set comparatively small. As compared to a power tool having an inner rotor type electric motor, the follower gear 21 can have a smaller diameter. Consequently, the center height H1 can be made short. The center height H1 is the height between an upper end edge of the tool main body 2 (the front housing 20, the intermediate base 18, or the main body housing 2a), which houses the follower gear 21, and the rotational axis J22 of the bit 33.

Because the center height H1 is less, the bit 33 can approach a wall, for example, in order to tighten a screw (edge driving). As a result, the operability of the power tool 1 when screw tightening at a corner is improved.

The follower gear 21 can have a comparatively small diameter. Consequently, the distance between the rotational axis J22 of the bit holder 31 (i.e., the bit 33) and the motor rotational axis J10 can be made small. The distance between the rotational axes J22, J10 is set small such that the rotational axis J22 is located within the diameter of the rotor 12 (the outer rotor) of the electric motor 10. As a result, the center height H1 of the power tool 1 can be set short.

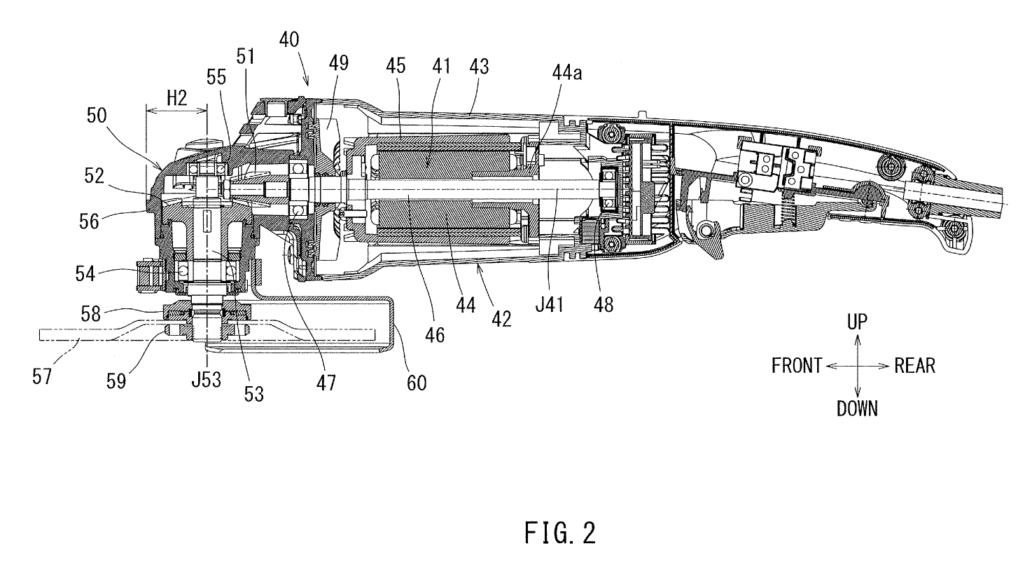

The power tool 40 shown in FIG. 2 is a disc grinder and comprises a tool main body 42 and a gear head part 50. The tool main body 42 houses an electric motor 41, which serves as a drive source. The gear head part 50 is coupled to a front part of the tool main body 42. A main body housing 43 of the tool main body 42 has a circular cylindrical shape and functions as a grip that is gripped by a user.

The electric motor 41 is an outer rotor type and can output high torque at a rotational speed that is lower than that of an inner rotor type electric motor. The electric motor 41 comprises a rotor (outer rotor) 45, which is rotatably supported on an outer side of a stator 44. The stator 44 has a circular cylindrical shape and is fixed to a rear part of the main body housing 43 via a pedestal part 44a. A motor shaft 46, which is mounted on the rotor 45, is rotatably supported by the main body housing 43 via bearings 47, 48. A fan 49, which is for cooling, is mounted on the motor shaft 46 on the front side of the rotor 45.

A tip part of the motor shaft 46 protrudes from the main body housing 43 and advances into the gear head part 50. Inside the gear head part 50, a drive gear 51 is mounted on the tip of the motor shaft 46. The drive gear 51 meshes with a follower gear 52. A bevel gear can be used as the follower gear 52, which is mounted on a spindle 53. The spindle 53 is rotatably supported by a gear head housing 56 of the gear head part 50 via bearings 54, 55. The rotational axis J53 of the spindle 53 is orthogonal to a motor axis J41 of the electric motor 41.

A lower part of the spindle 53 protrudes downward from the gear head housing 56. A circularly-shaped grinding wheel 57 is interposed between a receiving flange 58 and a fixing nut 59, and is attached to the lower part of the spindle 53. A rear semi-circumferential area of the grinding wheel 57 is covered by a grinding wheel cover 60. The grinding wheel cover 60 is fixed to the lower part of the gear head housing 56.

As described above, the electric motor 41 is an outer rotor type, the same as the electric motor 10 shown in FIG. 1. Accordingly, the electric motor 41 can output high torque at a rotational speed lower than that of an inner rotor type electric motor. Consequently, the speed reduction ratio of the gear train that comprises the drive gear 51 and the follower gear 52 can be set smaller than that of a structure having an inner rotor type electric motor as the drive source. As a result, the follower gear 52 can have a comparatively small diameter.

A bevel gear having a comparatively small diameter can be used as the follower gear 52. Consequently, the distance (center height H2) from the rotational axis J53 of the spindle 53 to a front end edge of the gear head housing 56 can be made short. Because the center height H2 in the disc grinder can be made short, the depth of cut by the grinding wheel 57 into the work material can be made larger. As a result, the operability of the power tool 40 can be improved.

Because the follower gear 52 has a smaller diameter, the spindle 53 (the rotational axis J53) can be closer to the electric motor 41 side (the rear side). Thereby, the drive gear 51, which meshes with the follower gear 52, can be relatively closer to the rotational axis J53 of the spindle 53. The tip part of the drive gear 51 and the tip part of the motor shaft 46 can be installed within the diameter of the bearing 55, which rotatably supports the spindle 53. The extent to which the gear head part 50 overhangs frontward from the tool main body 42 can be reduced, and thereby the front part of the power tool 40 can be made shorter. As a result, the operability of the power tool 40 can be improved.

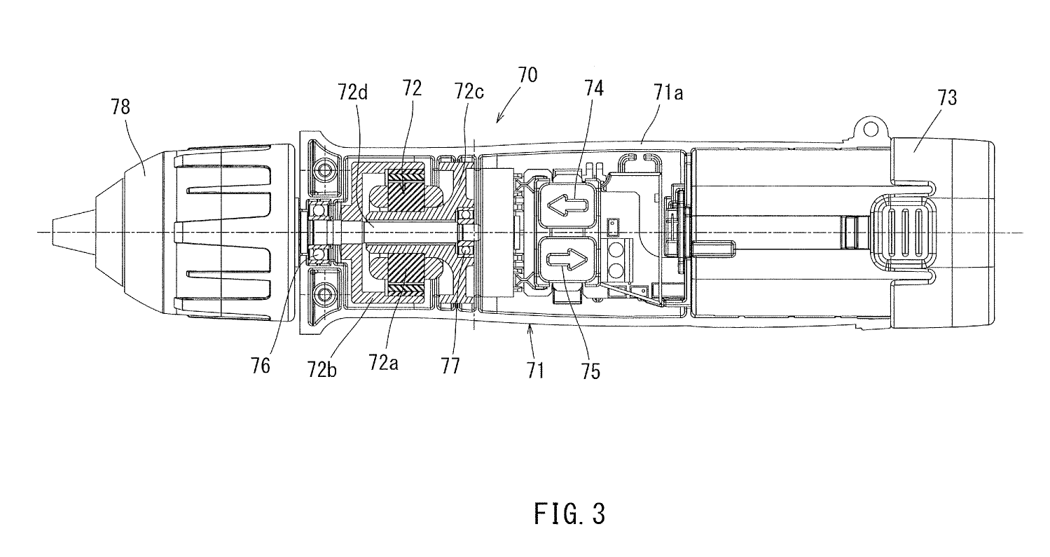

FIG. 3 shows a power tool 70, which is principally for performing drilling work and screw tightening work. The power tool 70 is a straight type hand-held tool and comprises a columnar tool main body 71. With respect to the power tool 70, unlike the power tool 1 shown in FIG. 1, a user grasps the tool main body 71 itself and uses the power tool 70.

The tool main body 71 houses an electric motor 72, which serves as a drive source. A battery pack 73, which serves as a power supply, is mounted at a rear part of the tool main body 71. A push button type forward rotation switch 74, which starts the electric motor 72 in the forward rotation, and a push button type reverse rotation switch 75, which starts the electric motor 72 in the reverse rotation, are provided on a side part of the tool main body 71. When the forward rotation switch 74 is pushed, the electric motor 72 starts in the forward rotation, whereupon screw tightening work can be performed using a driver bit or drilling work can be performed using a drill bit. When the reverse rotation switch 75 is pushed, the electric motor 72 starts in the reverse rotation, whereupon screw loosening work can be performed using a driver bit. When the pushing of the forward rotation switch 74 or the reverse rotation switch 75 is released, the electric motor 72 stops.

The electric motor 72 comprises an outer rotor type electric motor, which is capable of outputting high torque at a low rotational speed. The electric motor 72 comprises a rotor (outer rotor) 72b, which is rotatably supported on an outer circumferential side of a stator 72a. The stator 72a is fixed to a main body housing 71a via a pedestal part 72c. The rotor 72b is fixed to a motor shaft 72d. The motor shaft 72d is rotatably supported via bearings 76, 77.

The tip part of the motor shaft 72d protrudes frontward from a front part of the main body housing 71a. A drill chuck 78 is directly attached to a tip part of the motor shaft 72d. A tool accessory (not illustrated), such as a drill bit, is mounted on the drill chuck 78. The rotational output of the electric motor 72 is directed to the tool accessory without transiting a speed reducing means that operates by the meshing of gears of, for example, a spur gear train, a planetary gear train, and the like. Namely, the power tool 70 is a direct drive type drilling tool.

The outer rotor type electric motor 72, which is capable of outputting high torque at a low rotational speed, is provided in the interior of the power tool 70 and serves as the drive source. Consequently, the power tool 70 can output an appropriate rotational speed and drilling torque for the tool accessory without the interposition of a speed reducing means such as a gear train.

The power tool 70 does not comprise a speed reducing means between the electric motor 72 and the drill chuck 78. Consequently, the overall length (the machine length) of the power tool 70 can be made short. As a result, the convenience and operability of the power tool 70 can be improved.

The rotational motive power of the electric motor 72 is output directly to the tool accessory without passing through a speed reducing means. Consequently, energy loss is low and a high motive power transmission efficiency can be achieved.

Because the speed reducing means can be omitted, the overall tool main body 71 can be made shorter as a whole as well as in the longitudinal direction. Thereby, the handling properties of the power tool 70 can be greatly improved.

The embodiments of the present invention were explained with reference to the abovementioned structures, and it is understood that it would be obvious to a person skilled in the art that a variety of substitutions, variations, and modifications could be effected without departing from the spirit and scope of the invention. Accordingly, the embodiments of the present invention can encompass all substitutions, variations, and modifications that do not depart from the spirit and scope of the attached claims.

1. A power tool, comprising:
an electric motor;
a spindle configured to be attached to a tool accessory; and
a gear train configured to transmit rotational output of the electric motor to the spindle;
wherein the electric motor is an outer rotor motor.

2. The power tool according to claim 1, wherein
the spindle is disposed parallel to a motor axis of the electric motor; and
a rotational axis of the spindle is located in an area that corresponds to a diameter of an outer rotor of the electric motor.

3. The power tool according to claim 1, wherein
the spindle is disposed such that it intersects a motor axis of the electric motor; and
a tip part of a motor shaft of the electric motor is located in an area that corresponds to a diameter of a bearing that rotatably supports the spindle.

4. The power tool according to claim 1, further comprising:
a motor shaft of the electric motor; and
an intermediate base configured to rotatably support both a front end of the motor shaft and a rear end of the spindle.

5. The power tool according to claim 4, further comprising:
a main body housing configured to house the electric motor; and
a front housing configured to house the spindle;
wherein the intermediate base is located between the main body housing and the front housing, the intermediate base having an upper surface located not lower than the main body housing and the front housing.

6. The power tool according to claim 5, wherein the intermediate base has a lower surface opposite to the upper surface, and wherein the lower surface is exposed at an outside of the power tool.

7. The power tool according to claim 1, further comprising:
a fan integrally attached to a motor shaft of the electric motor; and
a facing portion configured to face the fan;
wherein the facing portion is provided on an outer rotor of the electric motor.

8. The power tool according to claim 1, wherein:
the motor comprises a rotor having an axis of rotation and a stator inside the rotor and
a motor shaft is attached to the rotor for rotation with the rotor and has an axis of rotation on the axis of rotation of the rotor.

9. The power tool according to claim 1, wherein:
the motor comprises a rotor having an axis of rotation and a stator inside the rotor and
a motor shaft is attached to the rotor for rotation with the rotor, the motor shaft extending through the stator.

10. The power tool according to claim 1, wherein:
the spindle is disposed parallel to a motor axis of the electric motor and has a rotational axis;
the outer rotor is shaped as a circular cylinder and
a virtual projection of the rotational axis of the spindle intersects a space encompassed by the circular cylinder.

11. A power tool, comprising:
an electric motor; and
a spindle attachable to a tool accessory;
wherein the electric motor is an outer rotor motor.

12. The power tool according to claim 11, wherein the electric motor comprises:
a stator non-rotatably coupled to a rear part of a main body housing that surrounds the electric motor and
a circular-cylindrical rotor rotatably disposed around an outer circumference of the stator.

13. The power tool according to claim 12, wherein:
the rotor has an outer diameter;
the spindle has a rotational axis and
a virtual projection of the rotational axis of the spindle falls within the outer diameter of the rotor.

14. The power tool according to claim 13, further comprising:
a motor shaft integrally attached to the rotor so as to rotate therewith;
an intermediate base coupled to a front part of the main body housing;
a first bearing attached to the intermediate base and rotatably supporting a forward portion of the motor shaft and
a front housing coupled to the intermediate base on a side opposite of the main body housing, a front end of the motor shaft extending into a space encompassed by the front housing.

15. The power tool according to claim 14, further comprising:
a drive gear attached to the front end of the motor shaft and disposed within the space encompassed by the front housing,
a follower gear meshing with the drive gear and disposed within the space encompassed by the front housing, and
a drive shaft fixed to the follower gear and rotatably supported by a bearing attached to the intermediate base, the drive shaft having a rotational axis that is parallel to a rotational axis of the rotor and collinear with the rotational axis of the spindle.

16. The power tool according to claim 12, wherein:
the rotor has an outer diameter and a rotational axis,
the spindle has a rotational axis that is perpendicular to the rotational axis of the rotor,
a bearing supports one end of the spindle, and
the bearing is located within a virtual projection of the outer diameter of the rotor.

17. The power tool according to claim 16, further comprising:
a motor shaft integrally attached to the rotor so as to rotate therewith;
a drive gear mounted on a forward end of the motor shaft and
a bevel gear meshing with the drive gear, the spindle being integrally attached to the bevel gear so as to rotate therewith.

18. The power tool according to claim 17, wherein:
the bearing has an outer diameter and
a tip end of the forward end of the motor shaft falls within a virtual projection of the outer diameter of the bearing.
